(19) United States
(12) Patent Application Publication
(10) Pub. No.: US 2020/0398543 A1
(43) Pub. Date: Dec. 24, 2020

(54) Protective, Adhesive Sheet Material

(71) Applicant: Craig Greiner, Foothill Ranch, CA (US)

(72) Inventor: Craig Greiner, Foothill Ranch, CA (US)

(21) Appl. No.: 16/902,224

(22) Filed: Jun. 15, 2020

Related U.S. Application Data
(60) Provisional application No. 62/864,377, filed on Jun. 20, 2019.

(51) Int. Cl. B32B 27/30; B32B 27/36; B32B 27/20; C09J 7/25; C09J 7/29

(52) U.S. Cl. CPC B32B 27/304; B32B 27/365; B32B 27/20; C09J 7/25; C09J 2427/006; B32B 2405/00; B32B 2307/41; B32B 2307/402; B32B 2307/414; C09J 7/29

(57) ABSTRACT

A multilayer protective sheet material with an adhesive backing is both durable and easy to install and conforms FAA standards. This sheet material may also include on optional layer of colored pigment.

### FIELD OF THE INVENTIONS

The inventions described below relate to the field of protective liners for airline bulkheads, carts and bins,

### BACKGROUND OF THE INVENTIONS

The airline industry spends millions of dollars annually to maintain and improve their equipment and facilities. Conventional sheet material that conforms to Federal Aviation Administration (FAA) standards for aircraft material does not provide a suitable balance between protection and ease of installation. These sheet materials are generally single color and are generally suitable for use in only a single application in an aircraft.

### SUMMARY

The devices and methods described below provide for a multilayer protective sheet material with an adhesive backing that is both durable and easy to install and conforms to FAA standards. This sheet material may also include on optional layer of colored pigment that may be sandwiched between the protective layer and the adhesive. The multilayer protective sheet material is suitable for application to bulkheads, bins, carts and any other suitable locations in a commercial aircraft.

### BRIEF DESCRIPTION OF THE DRAWINGS

FIG. 1 is an exploded perspective view of the layers of a protective sheet material.

FIG. 2 is an exploded side view of the protective sheet material of FIG. 1.

FIG. 3 is an exploded perspective view of the layers of an alternate protective sheet material.

FIG. 4 is an exploded side view of the alternate protective sheet material of FIG. 3.

### DETAILED DESCRIPTION OF THE INVENTIONS

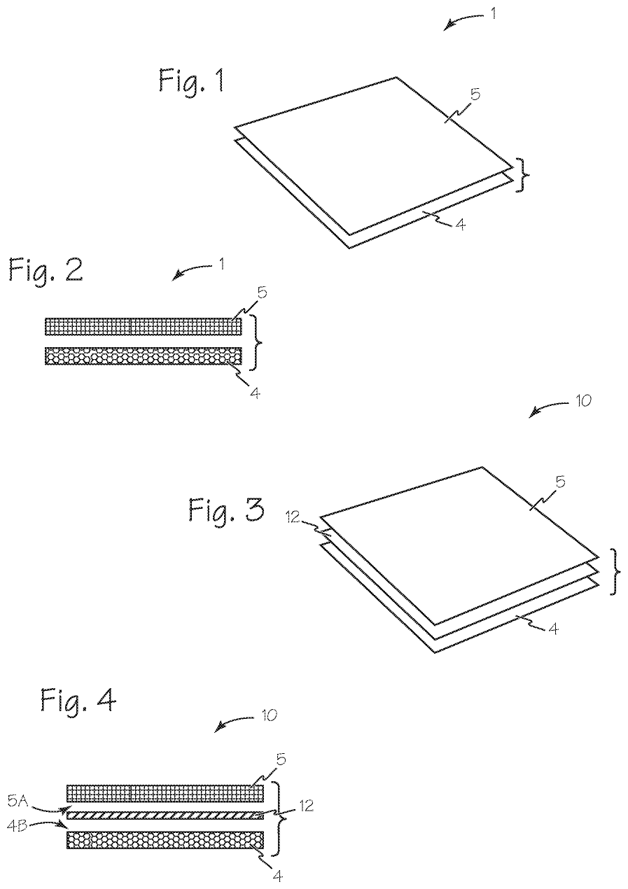

FIG. 1 is an exploded perspective view of the layers of protective sheet material 1. FIG. 2 is an exploded side view of the protective sheet material 1. Protective sheet material 1 is formed of two or more layers, adhesive layer 4 and protective layer 5. Protective layer 5 is a generally translucent top layer formed of any suitable polyvinyl fluoride such as Tedlar® or any suitable polycarbonate. Protective layer 5 is generally 8 mils (0.008″) thick when it is translucent, and it may also be an opaque pre-pigmented polycarbonate that is generally 10 mils (0.010″) thick. Adhesive layer 4 may be any adhesive suitable for a selected application on commercial airlines. For example, 9372 adhesive made by 3M® may be used in some applications but may not be suitable for others.

FIG. 3 is an exploded perspective view of the layers of an alternate protective sheet material 10. FIG. 4 is an exploded side view of the alternate protective sheet material 10. Protective layer 5 is an 8 mil (0.008″) translucent layer and pigment layer 12 is a 2 mil thick (0.002″) layer of color applied to either the inside, side 5A, of the protective layer or it may be applied to the outside, side 4B, of the adhesive layer.

In use, the choice of which type of protective layer 5 to be combined with which type of adhesive layer 4, coupled with the addition of pigment layer 12 enables the formation of protective sheet material that will comply with the safety regulations suitable for any location in a commercial vehicle. For example, material for covering the storage bins in an aircraft must comply with fire, smoke and extinguishment standards while covering for a beverage cart in a commercial aircraft must meet the fire, smoke and extinguishment standards as well as antibacterial standards. The ability to combine different protective layers with different adhesive layers with a sandwiched layer of pigment will permit these protective sheets to be used anywhere in a commercial aircraft and permit airlines to control weight and keep their fleets looking nicer longer and change coverings easier.

While the preferred embodiments of the devices and methods have been described in reference to the environment in which they were developed, they are merely illustrative of the principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

We claim:

1. A protective sheet material suitable for application on commercial airplanes comprising:
a protective layer formed of polyvinyl fluoride; and
an adhesive layer.

2. the protective sheet material of claim 1 further comprising a layer of colored pigment between the protective layer and the adhesive layer.

3. A protective sheet material suitable for application on commercial airplanes comprising:
a protective layer formed of translucent polycarbonate;
a layer of colored pigment; and
an adhesive layer.

4. The protective sheet material of claim 3 wherein the layer of colored pigment is between the protective layer and the adhesive layer.

5. The protective sheet material of claim 4 wherein the layer of colored pigment is applied to the protective layer.

6. The protective sheet material of claim 4 wherein the layer of colored pigment is applied to the adhesive layer.
